(19) United States
(12) Patent Application Publication
(10) Pub. No.: US 2020/0027235 A1
(43) Pub. Date: Jan. 23, 2020

(54) DEVICE FOR MONITORING THE VIEWING DIRECTION OF A PERSON

(71) Applicant: Nicolas BISSANTZ, Nürnberg (DE)

(72) Inventor: Nicolas BISSANTZ, Nürnberg (DE)

(21) Appl. No.: 16/491,288

(22) PCT Filed: Mar. 8, 2018
(86) PCT No.: PCT/EP2018/055827

§ 371 Date: Sep. 5, 2019

(30) Foreign Application Priority Data
Mar. 8, 2017 (DE) 10 2017 002 236.4

(51) Int. Cl. G06T 7/70; H04N 5/247; G06T 7/30

(52) U.S. Cl. CPC G06T 7/70; H04N 5/247; G06T 7/30; G08B 7/06; G06T 2207/30268; G06T 2207/30252; G06T 2207/30201

(57) ABSTRACT

The invention relates to a device for monitoring the viewing direction of a person, wherein the device comprises at least a first detection means for detecting the viewing direction of the person, and a second detection means for detecting at least one object, wherein the device moreover comprises at least one computing unit, which is configured to establish if the viewing direction of the person determined by the first detection means is directed at the object detected by the second detection means, and wherein the device comprises at least one output means, which is configured to output an optical and/or acoustic signal, depending upon one or multiple parameter(s), wherein the signal is output in a region which lies in a direction between the person and the object and/or in the region of the field of vision of the person facing the object, wherein one of the parameters relates to the result of the computing unit that the viewing direction of the person is not directed at the object.

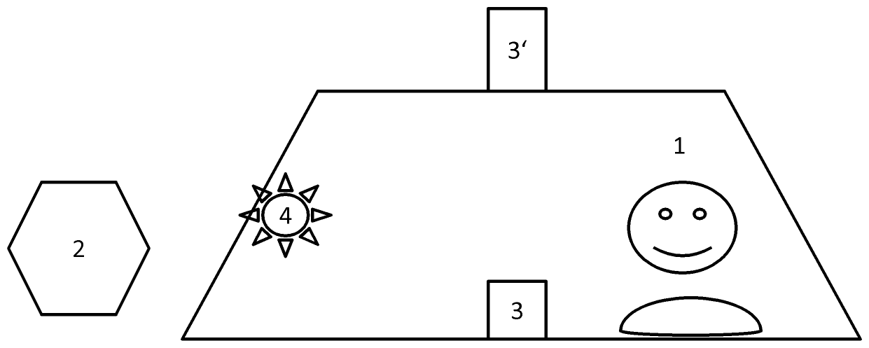

The invention relates to a device for the monitoring of the viewing direction of a person.

The sense of sight or the far sense is the sense upon which humans usually rely most strongly. Approx. 1 million photoreceptors on the retina alone are dedicated to sight, while only around 60,000 cilia are present in the cochlea. Large areas of the brain are occupied with sight.

Nevertheless, sight is a highly illusory process, which successfully misguides us about the physiological limitations of the eye and the tricks of the brain to overcome it. The sense of sight generates the semblance that the world were to stand forth in front of our eyes, over our entire field of vision at every moment and without any delay, gapless, unblemished, sharp and colorful.

In fact, however, only the smallest part of the eye, the fovea, delivers truly sharp and colorful image points to the brain. It has a diameter of around one millimeter. It therefore only covers 1-2 angular degrees of the field of vision, that corresponds to the size of a thumbnail at roughly an arm's length distance. The rest of the field of vision remains substantially uncolorful and unclear.

We notice this when reading. We always only see a few letters truly clearly. The eye must incessantly direct the fovea to new regions within the field of vision, which is associated with the least movements of the eye when reading. The eye movements to that end are automatized, non-linear, and are only partially subject to a conscious control. We must laboriously learn the linear movements necessary for reading, they are not natural.

Because the eye can always only take a few smallest sharp and colorful spot checks per second, the image formation would take much too long in order to be able to orient oneself securely in the world. For that reason, the brain constructs the rest of the image sufficiently exactly thereto.

As details are not, or at least not exactly perceived here, and the taking of random samples by the eyes is not linear, large tables appear as “dead figures” to us. If we view graphics or tables, we thus always see them as a whole, like everything else in front of us. In order to understand said figures, we must read them as text, however, and force the eye into linear movements. We do not see tables and graphics, we read them. We hardly have practice therewith, and many graphic formats require difficult movement sequences, in order to surely decode them.

Due to the nature of the sense of sight, it happens that objects lying in the field of vision of a person are not sufficiently well perceived or overlooked. This can also take place in situations in which these objects can represent an impairment or danger or in which of these objects heed must absolutely be paid.

If, for example, the driver of a vehicle does not, or only too late recognize an object approaching them, for example another vehicle, or a pedestrian, this can thus lead to accidents.

In a different situation, in which a person would like to grasp and understand complex visual data, for example on a screen, the order of the data detected can be decisive for the understanding thereof. Here, it can be difficult, in particular with complex data, for a viewer to swiftly find and grasp the most relevant data. The comprehension of the shown data is thusly possibly also made more difficult.

Against this background, it is the object of the invention to provide a device, which improves the awareness of a viewer to relevant objects.

According to the invention, this object is achieved by a device of claim 1. Advantageous configurations are the subject-matter of the dependent claims.

According thereto, it is provided that the device comprises at least a first detection means for detecting the viewing direction of the person and a second detection means for detecting at least one object, wherein the device further comprises at least one computing unit, which is configured to establish if the viewing direction of the person determined by the first detection means is directed at the object detected by the second detection means, and wherein the device comprises at least one output means, which is configured to output an optical and/or acoustic signal depending upon one or multiple parameter(s), wherein the signal is outputted in a region which lies in a direction between the person and the object and/or in the region of the field of vision of the person facing towards the object, wherein one of the parameters is the result of the computing unit that the viewing direction of the person is directed at the object.

The term object is to be understood in a broad sense and can, for example, refer to processes, objects, persons, or information displayed on and by means of a display.

Generally, the term the object can also be directed at information, processes, objects, persons, etc. relevant for a person.

According to the invention, at least one computing unit is provided which is configured to compute whether the viewing direction of the person is aimed at the detected object or not. According to the invention, at least one means is further provided for outputting a signal, inter alia, or exclusively depending upon the computation, wherein this means, if necessary, outputs an optical and/or acoustic signal, depending on one or multiple further parameters, if the viewing direction of the person does not point in the direction of the object.

The fact that the object is not located in the viewing direction of the person is a necessary, but not compulsory precondition for the generation of the optical and/or acoustic signal.

If, for example, a cyclist moves away from the car, no optical and/or acoustic signal is output, even if the viewing direction of the person is not aimed at the cyclist. This is not the case if the cyclist moves towards the person, because a collision can then take place.

In one embodiment, the signal can thusly be output at any moment, if the viewing direction of the person is not pointed in the direction of the objection, or be tied to one or multiple further preconditions.

These further preconditions can, for example, concern the question whether the object moves, in which direction the object moves, and what manner of object is concerned, etc. If, for example, a cyclist moves away from the person who is steering a vehicle, possibly no situation of danger exists, because no collision will occur, so that no optical and/or acoustic signal is generated, even if the cyclist is not located in the viewing direction of the person. The situation changes in the event that the cyclist moves towards the vehicle and it is determined that the viewing direction of the person, i.e. of the driver, is not aimed at the cyclist.

Advantageously, both the eye movement, for example of a driver or a person working in front of a screen, as well as the surroundings of the vehicle or the information displayed on the screen can itself, according to the invention, be detected or observed. According to the invention, it can further be compared if objects are located in regions or approach from regions, in which the person is not looking or which are not positioned in the viewing direction of the person. In an embodiment of the invention for monitoring the viewing direction of a person working at a screen, if a person is looking at a particularly relevant region of the screen for said regions or not can be compared. Should this not be the case, the optical and/or acoustic signal can be generated there, so that the attention of the person is drawn thereto.

With, for example, one or multiple light flashes in the windscreen, the side window, the rearview mirror, etc. of a vehicle, which preferably remain below the conscious perception threshold of the person, the view of the driver will be drawn to these regions of their surroundings. The light flashes can, of course, also be generated in other regions of the vehicle than in the region of the windscreen thereof.

In place or in addition to one or multiple light flashes, other optical signals and/or acoustic signals can also find use.

Preferably, these are natured such that they are only subconsciously perceived by a person.

Light and sound, i.e. a combination out of an optical and an acoustic signal is the strongest signal.

The sense of hearing/brain can detect/calculate differences in propagation time of 1/10,000 of a second between the ears and establishes the direction therefrom. Acoustic signals are thusly also suited for the present invention and in the scope of the same.

Insofar as reference is made to optical signals within the scope of the invention, these embodiments correspondingly also apply for acoustic signals and also for a combination of optical and/or acoustic signals.

It is conceivable, for example, that the computing unit, based on the data detected on the part of the detection units and/or based on further data made available to the computing unit, determines how far the field of vision of the person extends and positions signals or light flashes such that they lie at the edge of the field of vision of the person. The signals can, in particular, be positioned in the edge region of the field of vision which lies nearest to the object.

Preferably, the optical and/or the acoustic signal are generated in a region between the person and the object. This does not compulsorily mean that the signal must be exactly on the line between the person and the object, deviations, e.g. by ±20° from this direct line are also still included by the term “region”.

It is also conceivable that the object no longer lies in the field of vision of the person, which can be determined through field of vision detection means. In any case, in this case, the optical and/or also acoustic signal can be generated in that region of the field of vision which is nearest to the object.

In a use of a device according to the invention in conjunction with a computer screen or another information display, other, optically striking, e.g. colored and/or blinking signals and/or also acoustic signals can be generated, instead of light flashes, in the region of the display, which signals draw the attention of the observer to the corresponding region of the display.

In a preferred embodiment of the invention, it is conceivable that the signal is output in a region which is located in a direction between the person and the object. The signal can thusly be output in a region to be more exactly defined, depending on the situation, between the viewer or the person on the one hand, and the detected object on the other hand.

In one embodiment, it is provided that the signal output by the output unit is exclusively an optical signal. Additionally or alternatively, acoustic signals can be used.

The light source or the source for the acoustic signal(s), which generates the optical signals and/or acoustic signals, i.e. the output means, can include a single or multiple separate light sources or acoustic sources, which can be arranged in particular at different places within a vehicle. It is also conceivable that the light source is configured as a light emitter which, from a single position or from multiple positions, can illuminate different and in particular a plurality of places within the vehicle. Originating from a loudspeaker, a plurality of places within the vehicle, etc. can also targeted-orientedly “be ensonified”. Correspondingly capable loudspeakers have such a high manner of selectivity that, for example, four different programs may selectively be heard in four-way in vehicles. One can make use of this feature in order to place one or multiple acoustic signals at defined regions.

In a further preferred embodiment, it is conceivable that the signal is a light flash or a further optical and/or acoustic signal, which are/is in particular below the conscious perception or the conscious perception threshold of the person.

Here, it is known to a person skilled in the art that the light flash, to that end, must be, for example, sufficiently short and/or sufficiently dark. It is hereby avoided that the person illuminated with the light flash is dazzled, while it is simultaneously ensured that the light flash is sufficiently conspicuous in order to draw the attention of the person in the direction of the light flash. A suitable light flash can also be defined such that it does not overly distract or irritate the respective person.

In a further preferred embodiment, it is conceivable that the first detection means includes at least a first camera, which is orientable onto the face of the person, and which is configured to determine the viewing direction of the person. The camera can thusly detect the eyes or eye movements of the person, and thus provide data to the computing unit, on the basis of which this or a corresponding, algorithm know per se or corresponding programs can compute the viewing direction of the person.

In a particularly preferred embodiment, it is conceivable that the second detection means includes at least a second camera, which is orientable onto the surroundings of the person. The vehicle surroundings can be meant by the surroundings of the person when embodying the device in a vehicle. Here, for example, other road users, in the region of the vehicle, are detectable by means of the second camera(s). It is also conceivable that one and the same camera can be used to detect the face of the person and the surroundings of the person, i.e. that the first and the second detection means are formed by the same unit.

At this point, it is to be noted that the term “one/a” does not compulsorily refer exactly to one of the elements in question, even though this is a preferred configuration of the invention, but rather also includes a plurality of the elements. Correspondingly, the use of the plural form also includes a single element, and the use of the singular form also includes a plurality of the elements in question.

In a further preferred embodiment, it is conceivable that the detection means includes a display, which is configured to indicate the object as well as also the signal. This embodiment is applicable in particular in conjunction with, for example, a computer screen or another, in particular digital display. The object displayed by means of the display here, for example, can be an image information item particularly relevant for the person, e.g. the field of a table, which can be highlighted using a corresponding signal.

The signal can appear in direct proximity or exactly in the region of the displayed object. It is conceivable, for example, that the object itself is, for a short period of time, hidden and instead, an object different thereto is overlaid as a signal. The person skilled in the art can here preferably select the signal such that it can attract the attention of the person, for example through its brightness, its choice of color and/or its size and/or its sound level, frequency, duration, intensity, etc.

The output means can, for example, comprise one or multiple LEDs and/or one or multiple loudspeakers.

The output means can be configured to generate optical and/or acoustic signals of different characteristics, e.g. color, brightness, volume, frequency, etc., wherein the characteristics depend upon result of the examination made in the computing unit. Particularly critical results can, if necessary, be represented in a different color, etc. than less critical occurrences.

In a further preferred embodiment, it is conceivable that the computing unit is configured to differentiate and/or to prioritize objects at differently far distances from the person and/or moving in different directions. For this purpose, a corresponding program can be executed by means of the computing unit, which program, based on the detected data, can calculate how far which objects are located from the person and, if necessary, in which directions the objects and/or the person are moving. In the prioritizing of the objects, it can be taken into account whether determined positions of the objects and the position of the person as well as, if necessary, the determined directions of movement of the objects or of the person, lead to the conclusion of a collision of the object and the person.

Objects, which more strongly suggest a collision than other objects, can correspondingly be more highly weighted in the prioritization and be employed for outputting of a corresponding signal. If herein, reference is made to a plurality of objects, then the case that a single object is meant is also always included.

The present invention further relates to a vehicle or automobile with at least one device according to one of the preceding claims. Trucks, passenger vehicles, etc. are, for example, to be understood thereunder.

Here, the output means can be configured to generate the optical and/or acoustic signal in the region of one or both side windows or in at least one region of the windshield or in the region of one or both rear-view mirrors.

The present invention moreover relates to a crash helmet or a pair of glasses with at least one device according to one of the claims 1 to 9. Here also, an optical and/or acoustic signal can be generated, for example, on the visor or on the glasses lens or frame temples or on another location, which signal draws the attention of the motorcycle rider, cyclist, etc. to a danger situation.

As already explained above, the invention further relates to a computer with at least one device according to one of the claims 1 to 9, wherein the output means is formed by the computer screen. The term “computer” is here to be taken broadly, and includes every conceivable computing unit, e.g. a PC, laptop, tablet, smartphone, etc.

The invention is also aimed at a corresponding method, which is in particular executable by means of the above-mentioned device. Here, the method includes the steps of:
detection of the viewing direction of a person;
detection of the position and/or of the direction of movement of an object;
computing if the viewing direction is aimed at the object; and
Outputting an optical and/or acoustic signal depending on one or multiple parameters, wherein the signal is output in a region which lies in a direction between the person and the object and/or in the region of the field of vision of the person facing the object, wherein one of the parameters is the result of the computing unit that the viewing direction of the person is not directed at the object.

The method can also include further steps, which are executable in conjunction with the features which are named in conjunction with the device. A repetitive description related to this is omitted for the sake of simplicity.

Further details and advantages are explained based on an the exemplary embodiment shown in the figure.

The only figure shows a schematic view of the vehicle, in which a device according to the invention for monitoring the viewing direction of a person is implemented.

The means for detecting the viewing direction of the person 1 and the position of an object 2 can include a camera 3 arranged in particular in the interior space of the vehicle. To detect the position of the object 2, a further camera 3′ can be arranged in the region of the vehicle. An embodiment, in which a single camera 3 can detect the person 1, as well as the surroundings of the vehicle or the surroundings of the person 1, is also conceivable.

A computing unit (not shown) is configured to evaluate the data detected by the cameras 3, 3′ or the by the detection means, wherein it is in particular calculated if the viewing direction of the person 1 is aimed at the object 2 or not. The object 2 can in particular be objects, which approach the person 1. The computing unit can, in a particular embodiment, determine if this is the case, based on the detected data.

If the computing of the computing unit yields that the person 1 is looking in a different direction than that of the object 2, an output means 4 thus outputs a signal. The signal can thus be output depending upon the computation. The signal is here output in that region of the vehicle, which originating from the person 1 lies in the direction, in which is also located the object 2. Through the signal, the attention of the person 1 is drawn in the direction of the object 2, and it is made easier for the person 1 to more quickly perceive the object 2 and to react correspondingly.

The output means 4 for outputting the signal can here, for example, include diodes in the region of the vehicle interior, which diodes are actuated depending upon the position and/or direction of movement of the object 2.

It is also conceivable to direct a light ray, by means of the output means 4, into a corresponding region of the vehicle or of the field of vision of the person 1. The output means 4 can also include a central light source or a few light sources, which are configured, in the region of the field of vision of the person 1, to generate or to project light emissions or light flashes.

The generated signal or the light flash can be defined such that lies below the conscious perception source of the person 1. It is thereby ensured that said output can subconsciously be perceived, but can not lead to any distraction, or only to a very minor irritation or distraction of the person 1.

The exemplary embodiment also applies to acoustic signals, and also to a combination of acoustic and optical signals.

1. Device for monitoring the viewing direction of a person, comprising
at least one first detection means to detect the viewing direction of the person,
a second detection means to detect at least one object,
at least one computing unit, which is configured to establish if the viewing direction of the person determined by the first detection means are directed at the object detected by the second detection means, and
at least one output means, which is configured to output an optical and/or an acoustic signal, depending on one or multiple parameter(s), wherein
the signal is output in a region which lies in a direction between the person and the object and/or in the region of the field of vision of the person facing towards the object, and
one of the parameters is the result of the computing unit that the viewing direction of the person is not directed at the object.

2. Device according to claim 1, wherein the output means are at least at least one light source and/or a source for an acoustic signal, which is configured to output a preferably brief optical and/or acoustic signal.

3. Device according to claim 2, wherein the light source or the source for an acoustic signal is configured to output an optical and/or acoustic signal, the duration of which lies at <1 s.

4. Device according to claim 1, wherein the light source is configured to output an optical signal, in particular a light flash, which is only subconsciously perceivable by the person.

5. Device according to claim 1, wherein the first detection means includes at least a first camera, which is directed at the face of the person and which is configured to detect the viewing direction of the person.

6. Device according to claim 1, wherein the second detection means includes at least a second camera, which is directed at the surroundings of the person, and/or the second detection means are configured to detect the position and/or the direction of movement and/or the type of object.

7. Device according to claim 1, wherein the computing unit is configured to differentiate and/or to prioritize objects distanced differently far from the person and/or moving in different directions relative to the person.

8. Device according to claim 1, wherein the output means comprises one or multiple LEDs and/or one or multiple loudspeakers.

9. Device according to claim 1, wherein the output means are configured to generate optical signals of different color and/or to generate acoustic signals of different characteristics, and the color or the characteristic depends on the result of the examination undertaken in the computing unit.

10. Vehicle with at least one device according to claim 1.

11. Vehicle according to claim 10, wherein the output means are configured to generate the optical signal and/or the acoustic signal in the region of one or both side windows, or in at least one region of the windscreen, or in the region of one or both rear-view mirrors.

12. Crash helmet or glasses having at least one device according to claim 1.

13. Computer having at least one device according to claim 1, wherein the output means are formed by the computer screen.

14. Method for monitoring the viewing direction of a person, comprising the steps of:
detecting the viewing direction of a person;
detecting an object;
computing whether the viewing direction is directed at the object; and
outputting an optical and/or acoustic signal, depending upon one or multiple parameter(s), wherein
the signal is output into a region which lies in a direction between the person and the object and/or in the region of the field of vision of the person facing the object, and
one of the parameters is the result of the computing unit that the viewing direction of the person is not directed at the object.

15. Device according to claim 3, wherein the light source is configured to output an optical signal, in particular a light flash, which is only subconsciously perceivable by the person.

16. Device according to claim 2, wherein the light source is configured to output an optical signal, in particular a light flash, which is only subconsciously perceivable by the person.

17. Device according to claim 16, wherein the first detection means includes at least a first camera, which is directed at the face of the person and which is configured to detect the viewing direction of the person.

18. Device according to claim 15, wherein the first detection means includes at least a first camera, which is directed at the face of the person and which is configured to detect the viewing direction of the person.

19. Device according to claim 4, wherein the first detection means includes at least a first camera, which is directed at the face of the person and which is configured to detect the viewing direction of the person.

20. Device according to claim 3, wherein the first detection means includes at least a first camera, which is directed at the face of the person and which is configured to detect the viewing direction of the person.
